(19) United States
(12) Patent Application Publication
(10) Pub. No.: US 2026/0318649 A1
(43) Pub. Date: Oct. 15, 2026

(54) HOLOGRAPHIC WEAPON SIGHT AND MANUFACTURING METHOD

(71) Applicant: EOTech, LLC, Plymouth, MI (US)

(72) Inventors: Brian Bellah, Orofino, ID (US); Waylin Wing, Ann Arbor, MI (US); Abram Summerfield, Orofino, ID (US); Anthony Heath, Plymouth, MI (US)

(73) Assignee: EOTech, LLC, Plymouth, MI (US)

(21) Appl. No.: 19/461,354

(22) Filed: Jan. 27, 2026

Related U.S. Application Data
(60) Provisional application No. 63/749,924, filed on Jan. 27, 2025.

(51) Int. Cl. F41G 1/16

(52) U.S. Cl. CPC F41G 1/16

(57) ABSTRACT

An optical component carrier for a holographic sight includes a chassis and an adjustment member. The chassis may be comprised of a metal sheet formed to at least partially define an optical window and a mating surface. The mating surface may be configured to support an optical component used for illuminating a holographic image in the optical window. The chassis may be configured to move about a sighting axis relative to the housing for positional adjustment of the optical window and the illuminated holographic image in a viewing window defined by the housing. The adjustment member may be fixed to the chassis and may include a first surface and a second surface orthogonal to the first surface. At least one of the first surface or the second surface may be configured to receive a force to drive movement of the chassis about the sighting axis.

### CROSS-REFERENCE TO RELATED APPLICATION

This application claims the benefit and priority under 35 U.S.C. §119(e) of U.S. provisional application Ser. No. 63/749,924, filed on Jan. 27, 2025, the content of which is incorporated herein by reference in its entirety.

### TECHNICAL FIELD

The present disclosure relates generally to a holographic weapon sight, and more specifically to an optical component carrier for coupling with a holographic weapon sight.

### BACKGROUND

Weapon sights are utilized to assist a weapon operator in locating and aiming the weapon at a target. Holographic sights provide a holographic image in the weapon operator’s field of view with information and/or reticles to assist the operator in a reliable and accurate manner. The optical components of a holographic sight each require accurate positioning and alignment relative to each other when manufacturing a holographic weapon sight, such that assembly typically requires a high degree of precision and testing can result in scrap or difficult rebuilds to remove and reattach any misaligned optical components.

### SUMMARY

According to one aspect, an optical component carrier for a holographic weapon sight includes a chassis and an adjustment member. The chassis may be comprised of a metal sheet formed to at least partially define an optical window and a mating surface. The mating surface may be configured to support an optical component used for illuminating a holographic image in the optical window. The chassis may be configured to move about a sighting axis relative to a housing of the holographic weapon sight for positional adjustment of the optical window and the illuminated holographic image in a viewing window defined by the housing. The adjustment member may be fixed to the chassis and may include a first surface and a second surface orthogonal to the first surface. At least one of the first surface or the second surface may be configured to receive a force to drive movement of the chassis about the sighting axis.

Also, according to another aspect, a holographic weapon sight may include a housing and an optical component carrier for coupling with the housing. The optical component carrier may include a first carrier part, a second carrier part, and a plurality of optical components. The first carrier part may be comprised of a first metal sheet having at least a mounting portion and defining a first optical component receptacle. The second carrier part may be comprised of a second metal sheet having an adjustment member and defining a second optical component receptacle. The plurality of optical components may be fixedly attached to the first and second optical component receptacles. The adjustment member may be configured to move the optical component carrier relative to the housing about a sighting axis of the mounting portion.

In another aspect, an optical component carrier for coupling with a housing of a holographic weapon sight may include a chassis comprising a metal sheet. The metal sheet may at least partially define a fixed optical component receptacle configured to support an optical component, and an adjustable optical component receptacle including a light source. The light source may be configured to emit a light path to the optical component. The adjustable optical component receptacle may include a first receptacle part and a second receptacle part. The first receptacle part may be configured for adjusting the light source in a first direction and a second direction. The second receptacle part may be configured for adjusting the light source in at least a third direction.

According to a further aspect, an optical component carrier for coupling with a housing of a holographic weapon sight may include a chassis and a plurality of optical components. The chassis may be comprised of a metal sheet formed to at least partially define a plurality of optical component receptacles. The plurality of optical components includes at least a light source and an image hologram for illuminating a holographic image in an optical window. Each of the plurality of optical components is secured to a respective optical component receptacle and configured to move in unison with the optical component carrier relative to the housing for positional adjustment of the displayed holographic image.

Also, according to yet another aspect, a holographic weapon sight may include a housing and a pre-assembled unitary optical component carrier insertably attached to the housing. The pre-assembled unitary optical component carrier may include a chassis comprised of a metal sheet including a carrier portion and a mating portion and formed to at least partially define an optical window and a plurality of receptacles. The pre-assembled unitary optical component carrier may also include a plurality of optical components each attached to a respective receptacle and configured to illuminate a holographic image to the optical window. The optical components may be configured to move dependently on the chassis about a sighting axis of the mating portion relative to the housing for positional adjustment of the holographic image in the optical window. The pre-assembled unitary optical component carrier may be connected to the housing by a fastener of the mating portion.

According to yet a further aspect, a method of manufacturing a holographic sight may include assembling an optical component carrier, providing an optical housing, insertably attaching the optical component carrier into an opening of the optical housing, and securing the optical component carrier to the optical housing. Assembling the optical component carrier may further include bending a first metal sheet into a first carrier part, bending a second metal sheet into a second carrier part, welding the first carrier part and the second carrier part to form a chassis at least partially defining a plurality of receptacles, affixing a plurality of fixed optical components to each of the plurality of receptacles, aligning a light source with the fixed optical components, and affixing the light source in an aligned position to the fixed optical components.

In some implementations, the optical component carrier includes an adjustable optical component receptacle having a first receptacle part configured for adjusting a light source in a first direction and a second direction, and a second receptacle part configured for adjusting the light source in at least a third direction. The light source may be aligned with fixed optical components including a collimating optic before being affixed in position.

In a further implementation, the optical components, including the light source, collimating optic, mirror, diffraction grating, and image hologram, are secured to respective receptacles on the chassis such that a position of each optical component is fixed relative to the other optical components, and all components move dependently with the chassis during positional adjustment.

### BRIEF DESCRIPTION OF THE DRAWINGS

FIG. 1A illustrates a rear, right, perspective view of a holographic sight.

FIG. 1B illustrates a rear, left, perspective view of the holographic sight of FIG. 1A.

FIG. 1C illustrates a front, left perspective view of the holographic sight of FIG. 1A.

FIG. 1D illustrates a side view of the holographic sight of FIG. 1A.

FIG. 1E illustrates a cross-sectional view of the holographic sight of FIG. 1A.

FIG. 2A illustrates a front, left perspective view of the holographic sight of FIG. 1A.

FIG. 2B illustrates a front, right perspective view of the holographic sight of FIG. 1A.

FIG. 3A illustrates a rear, perspective view of an optical component carrier.

FIG. 3B illustrates a front, perspective view of the optical component carrier of FIG. 3A.

FIG. 3C illustrates a side view of the optical component carrier of FIG. 3A.

FIG. 4A illustrates a rear, perspective view of an optical component carrier.

FIG. 4B illustrates a front, perspective view of the optical component carrier of FIG. 4A.

FIG. 4C illustrates a cross-sectional side view of the optical component carrier of FIG. 4A.

FIG. 5A illustrates a rear, perspective view of a chassis.

FIG. 5B illustrates a front, perspective view of the chassis of FIG. 5A.

FIG. 5C illustrates a rear view of the chassis of FIG. 5A.

FIG. 5D illustrates a side view of the chassis of FIG. 5A.

FIG. 6A illustrates a rear, perspective view of a first portion of a chassis.

FIG. 6B illustrates a rear view of the first portion of FIG. 6A.

FIG. 6C illustrates a side view of the first portion of FIG. 6A.

FIG. 7 illustrates an unbent metal sheet to be formed into the first portion of FIG. 6A.

FIG. 8A illustrates a rear, perspective view of a second portion of a chassis.

FIG. 8B illustrates a top view of the second portion of FIG. 8A.

FIG. 8C illustrates a side view of the second portion of FIG. 8A.

FIG. 9 illustrates an unbent metal sheet to be formed into the second portion of FIG. 8A.

The details of one or more examples of the disclosure are set forth in the accompanying drawings and the description below. Other aspects, advantages, purposes, and features will be apparent upon review of the following specification in conjunction with the drawings, where like reference numerals indicate like parts.

### DETAILED DESCRIPTION

Holographic sights may employ a series of optical components to generate a hologram for presentation to the operator. For example, a holographic sight may employ a light source, such as a light-emitting diode that generates a light beam, a collimating optic that receives the light beam and directs collimated light, a mirror that deflects the collimated light, a grating that receives the reflected collimated light and reflects light toward an image hologram that has been recorded with an image and which displays the image to the operator of the sight. Operation of the holographic sight requires that the optical components be in the intended relative positions, including distance and orientation, relative to each other. Even small variances from the intended position of even one of the optical components may negatively impact the generation of a hologram for use by the operator of the sight.

Holographic sights may position optical components relative to each other by affixing them to structures in a holographic sight. Because the optical components are attached to different components which themselves may be movable relative to each other, it may be difficult to place the optical components in their intended positions even in a controlled manufacturing environment. According to the disclosure, an optical component carrier is pre-assembled that may be insertably attached to a housing of a holographic sight. The optical component carrier may be comprised of a metal sheet via stamping to effectively manufacture a chassis for supporting the optical components. The chassis may include fixed optical component receptacles that receive the optical components. For example, the receptacles may be surfaces to which the optical components are adhered. The fixed optical component receptacles may include mating surfaces and/or walls to assist with aligning the optical components in their defined, intended locations. The chassis may define an adjustable optical component receptacle for receiving a light source and a light source carrier. The light source is adjustable in the adjustable component receptacle via the carrier to adjust the light source to calibrate the light path to the other of the optical components, and in particular to the collimating optic. Once calibrated and aligned, the light source and carrier may be fixed to the chassis, thus maintaining the intended aligned positions of all of the optical components to produce an illuminated holographic image in an optical window of the chassis.

The chassis may include an adjustment assembly for moving the optical component receptacle relative to the housing. Due to the fixed nature of the optical components, the location and distance between all of the optical components remains fixed while the optical component carrier moves relative to the housing to adjust the holographic image in the viewing window of the holographic sight. An adjustment member may extend from a target-facing side of the chassis. The adjustment member may include a first surface configured to be engaged by an elevation adjustment control via an elevation adjuster, and a second surface, orthogonal to the first surface, configured to be engaged by a windage adjustment control via a windage adjuster. The chassis may include a mounting portion on a user-facing surface. The mounting extension may extend from the chassis along a bend in the metal sheet forming a flexure axis. Force provided on the first surface of the adjustment member by the elevation adjustment control may cause the chassis to flex about the flexure axis, resulting in angular, vertical movement of the chassis, and thus the optical path and the holographic image. In other words, the flexure of the flexure axis by the elevation adjustment control causes elevation angular movement of the chassis about the flexure axis. The mounting portion may include a vertical axis formed via a mounting screw which extends through an aperture on a planar surface of the mounting portion and fastens the optical component carrier to the housing of the holographic sight. Horizontal force provided on the second surface of the adjustment member by the windage adjustment control may cause the chassis to rotate about the vertical axis, resulting in angular, horizontal movement of the chassis, and thus the optical path and the holographic image. In other words, the horizontal force on the second surface by the windage adjustment control causes azimuth angular movement of the chassis about the vertical axis.

According to the disclosure, a chassis is formed upon which all of the optical components of the holographic sight are fixed. The chassis may be comprised of a metal sheet, or in some instances, a first metal sheet and a second metal sheet. The metal sheets are stamped in production to reduce errors in formation. The chassis includes surface features or mating surfaces to align the optical components to reduce the level of precision necessary to align the optical components. The chassis includes an adjustment arm which may be engaged to move the optical component carrier, and thus the optical path and the holographic image relative to the housing, without moving the optical components relative to the optical component carrier, as all of the components are fixed to the carrier. Accordingly, a pre-assembled optical component carrier is provided which is insertably attached to a housing of a holographic sight and which may be manufactured with a lower level of necessary precision for the acceptable resulting optical performance, and while increasing production throughput and reducing waste from optical alignment issues in traditional holographic sights.

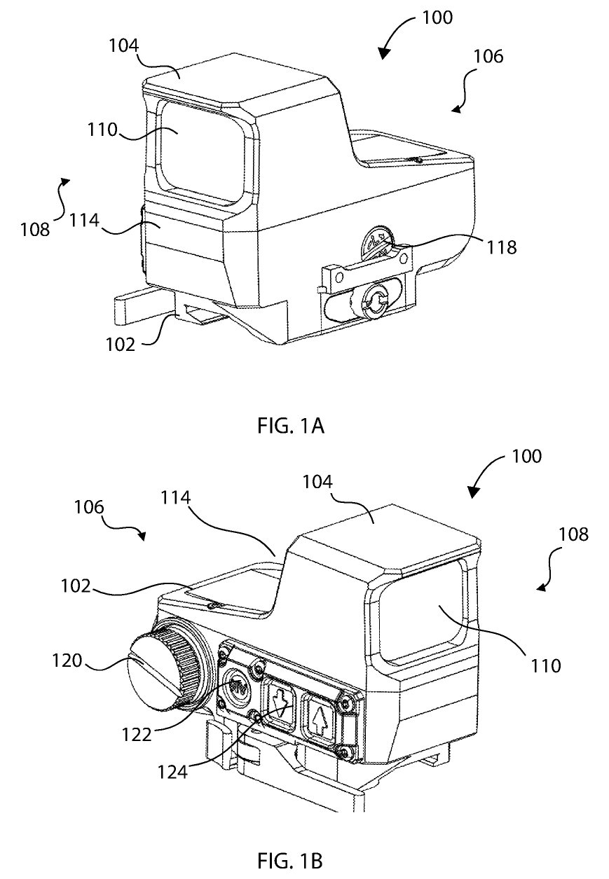

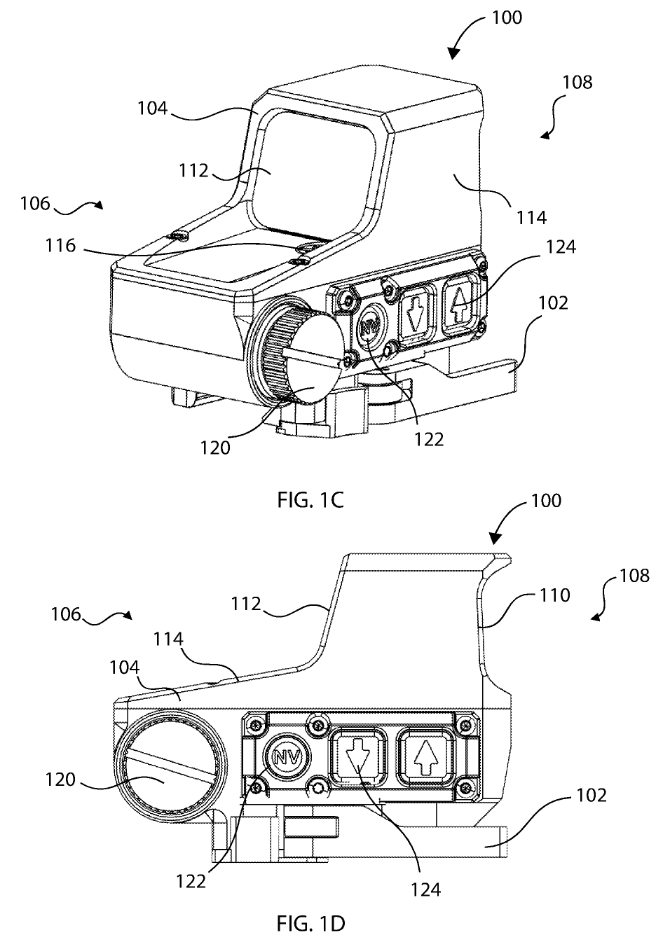

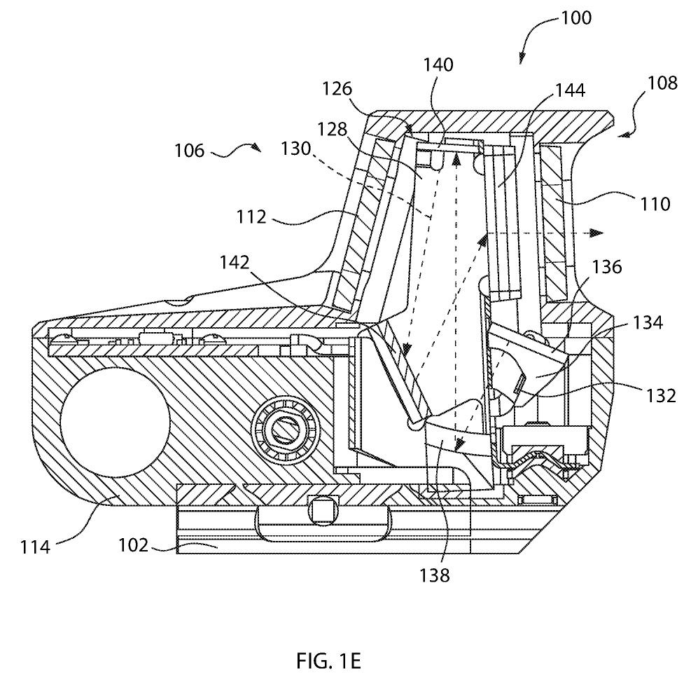

Referring to the figures, FIGS. 1A and 1B depict rear, right perspective and rear, left perspective views, respectively, of an example holographic sight 100. FIG. 1C depicts a front, left perspective view, and FIG. 1D depicts a side view of the example holographic sight 100. The holographic sight 100 may be adapted to be removably attached to a suitable weapon system, such as, for example, a firearm. The holographic sight 100 may comprise a base 102 that is configured to releasably engage with corresponding components on a firearm, such as a Picatinny rail, Weaver rail, or the like, in order to secure the holographic sight 100 to the firearm. As shown, the base 102 includes a downward-facing channel that slidably engages the rail and a pin that spans the channel and engages a lateral slot on the rail. The pin may include a lever that can function to clamp closed and release to threadably remove the pin.

As also shown in FIGS. 1A-1D, the holographic sight 100 includes a front end 106 (i.e., a target-facing side) and a rear end 108 (i.e., a user-facing side). An operator or user of the holographic sight 100 may look through a rear window 110 situated at the rear end 108 and aligned with a front window 112 situated at the front end 106. The area visible to the operator through the rear window 110 and the aligned front window 112 may be referred to as the viewing area. The holographic sight 100 is adapted to illuminate or otherwise display a holographic image in the viewing area defined by the rear window 110.

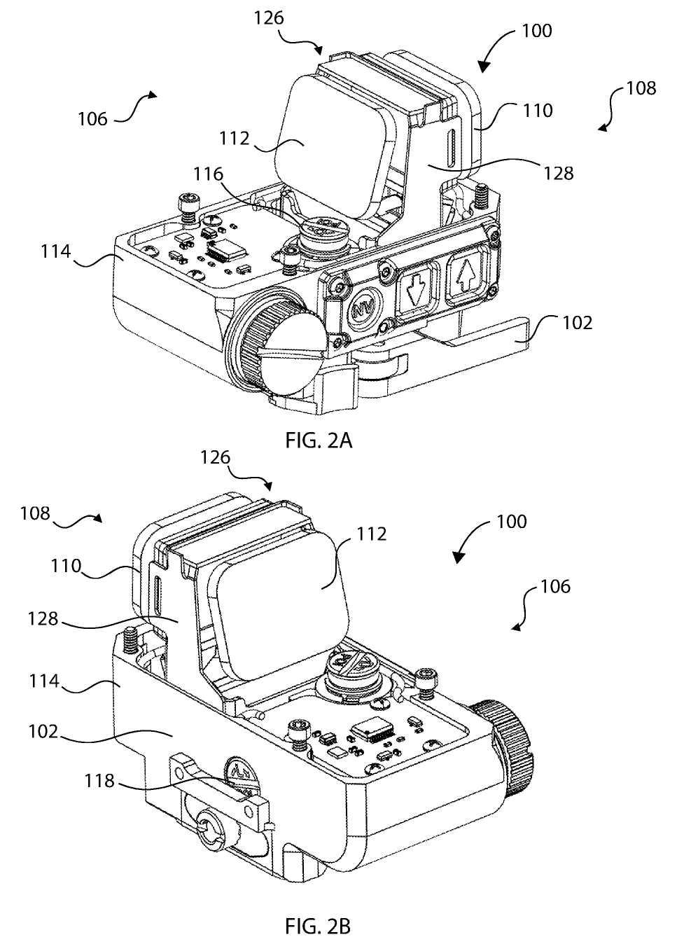

The holographic sight 100 includes a housing 114, which may surround and secure components of the holographic sight 100. As shown in FIGS. 1A-1D, the housing 114 has an upper portion 104 with longitudinally aligned front and rear openings that respectively receive the front and rear windows 112, 110, which are sealed about their perimeters to protect the interior of the housing 114. As shown, the upper portion is attached to the lower portion of the housing 114 as a separate part, which may be removed, as shown in FIGS. 2A and 2B. In additional examples, the upper portion and the lower portion may be integrally formed together. An elevation adjustment control 116 may be accessible via an opening in the housing 114, shown at a right side of the lower portion of the housing 114 (FIG. 1A). A windage adjustment control 118 may also be accessible via an opening in the housing 114, shown at a top wall of the upper portion of the housing 114 (FIG. 1C). An operator may turn the elevation adjustment control 116 and/or the windage adjustment control 118 to respectively adjust the vertical and horizontal locations of the holographic image in the viewing window as viewed through the rear window 110. A battery cap 120 may be located on the housing 114 to removably enclose and thereby provide access to an opening configured to receive a battery that provides electrical power to the holographic sight 100, and more specifically to the light source that illuminates the holographic image. The housing 114 may include depressible buttons to operate the sight, such as a night vision button 122 and buttons configured as brightness control buttons 124. A user or operator may depress the night vision button 122 and/or the brightness controls 124 to change the on/off state of the holographic sight 100, the brightness of the hologram, and/or toggle other controls and night vision controls of the holographic sight 100.

FIG. 1E depicts a cross-sectional view of the holographic sight 100. An optical component carrier 126 is movably coupled within the housing 114 of the holographic sight 100. The optical component carrier 126 may include a chassis 128 defined to support a plurality of optical components. For example, the chassis 128 may support at least one of a light source 132, a collimating optic 138, a mirror 140, a diffraction grating 142, and an image hologram 144. In an example, an optical path 130 (i.e., a light path) may travel from the light source 132, to the collimating optic 138, to the mirror 140, to the diffraction grating 142, and lastly to the image hologram 144, before exiting the rear window 110 to an operator. The optical path 130 may illuminate the holographic image in the viewing window defined by the housing 114. The light source 132 may be a light-emitting diode configured to generate visible light that is directed toward the collimating optic 138. The light source 132 may be affixed to a carrier 134 configured to assist with aligning the light source 132 with the collimating optic 138. The carrier 134 may support a control board 136 configured to operate the light source 132. The collimating optic 138 may be configured to receive the light from the light source 132 and direct light to the mirror 140. The collimating optic 138 may be, for example, transmissive or reflective. The mirror 140 is configured to receive the collimated light from the collimating optic 138 and to direct the light to the diffraction grating 142. The diffraction grating 142 is configured to reflect diffracted light toward the image hologram 144. The image hologram 144 is configured to then receive the light and project a holographic image that may be viewed in the viewing area of the holographic sight 100. The holographic sight 100 displays the holographic image to the operator through the viewing area presented by the rear window 110. The holographic image may be configured to assist an operator in targeting an object with the affixed weapon system. For example, the holographic image may be a reticle or other targeting or alignment markings or images, such as various types of reticle patterns and/or hash markings.

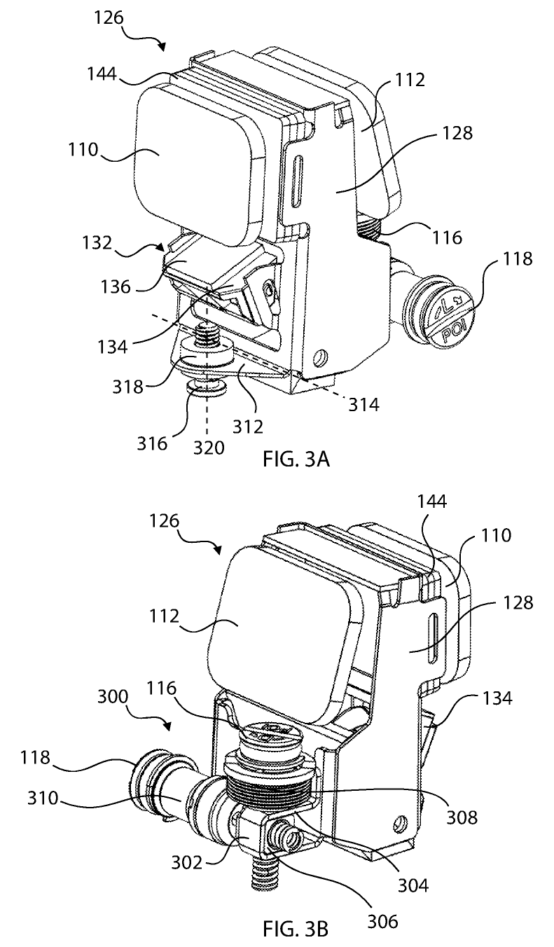

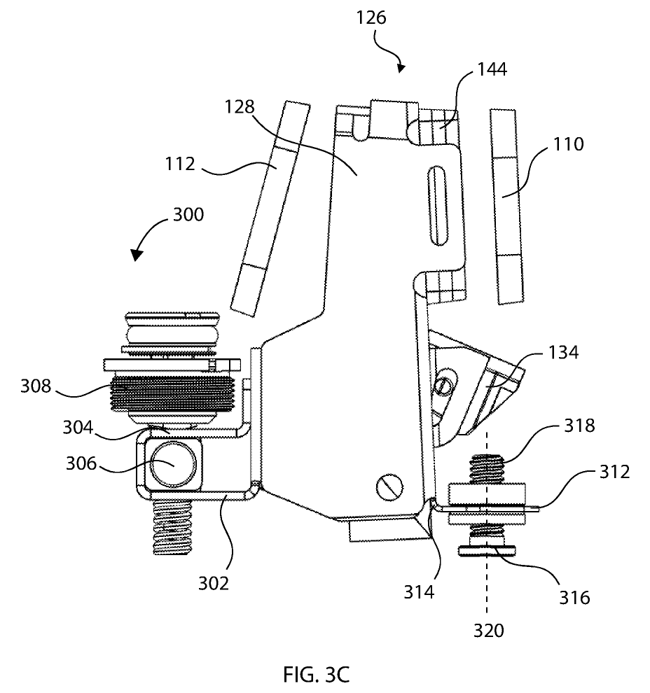

FIGS. 2A and 2B depict the holographic sight 100 without the upper portion 104, which may be a detachable piece that is fastened to the base 102 or lower portion of the housing upon assembly. With the upper portion 104 removed, the optical component carrier 126 is visible in the base 102 of the housing 114. The optical component carrier 126 may be fully manufactured as a single sub-assembly prior to inserting it in and coupling it with the housing 114. Thus, the plurality of optical components are each fixed relative to each other and relative to the chassis 128 of the optical component carrier 126 when the optical component carrier 126 is coupled to the housing 114. To positionally adjust the optical component carrier 126 relative to the housing 114, an adjustment assembly 300 may be provided that is accessible from the exterior of the housing 114. As shown in FIGS. 3A and 3B, the adjustment assembly 300 includes the elevation adjustment control 116 and the windage adjustment control 118, which provide positional adjustments to the chassis 128 relative to the housing 114, while maintaining a relative position of each of the plurality of optical components to each other and to the chassis 128.

The elevation adjustment control 116 may be a button or dial that extends through an upper surface of the base 102 of the housing 114. The elevation adjustment control 116 may also extend through an opening of the upper portion 104 of the housing so an operator may engage and adjust the elevation adjustment control 116. The windage adjustment control 118 may also be a button or a dial that extends through an opening in a side surface of the base 102 of the housing 114, so an operator may engage and adjust the windage adjustment control 118.

As shown in FIGS. 3A-3C, the elevation adjustment control 116 and the windage adjustment control 118 of the adjustment assembly 300 interface with an adjustment member 302 that extends from a front end 106 of the chassis 128. The adjustment member 302 may be configured as a tiller arm integrally extending from the chassis 128. The adjustment member 302 may include a first surface 304, which may be a top surface of the adjustment member 302, and a second surface 306 orthogonal to the first surface 304, which may be a side surface of the adjustment member 302. Because all optical components are fixed to the chassis 128, adjustment of the chassis position via the elevation adjustment control 116 or windage adjustment control 118 causes all optical components to move dependently with the chassis as a unit, maintaining their relative alignment while adjusting the position of the illuminated holographic image in the viewing window.

The elevation adjustment control 116 may be attached to an elevation adjuster 308 which extends through the base 102 to engage the first surface 304 of the adjustment member 302. An operator may turn the elevation adjustment control 116, which results in the elevation adjuster 308 engaging with the first surface 304 of the adjustment member 302. As the operator turns the elevation adjustment control 116, the elevation adjuster 308 applies more or less force to the first surface 304 of the adjustment member 302, which moves the adjustment member a distance corresponding to the degree of rotation of the elevation adjuster. The chassis 128 may include a mounting portion 312 which extends from a rear end 108 of the chassis 128. The adjustment assembly 300 may be configured to move the chassis 128 about a sighting axis relative to the housing 114. As shown in FIG. 3A, the sighting axis when operating the elevation adjustment control 116 may be a flexure axis. The metal sheet of the carrier 134 includes a bend between a carrier portion (i.e., a central portion) of the chassis 128 and the mounting portion 312, defining a mounting flange. The resilient bend thereby forms a first sighting axis (i.e., a flexure axis 314). As the elevation adjuster 308 applies more or less force to the first surface 304 of the adjustment member 302, the flexure axis 314 may be flexed, allowing the chassis 128, and thus the optical path 130 illuminating the holographic image formed through the fixed plurality of optical components, to move or be angularly displaced relative to the flexure axis 314 in the viewing window. Thus, vertical force applied to the first surface 304 of the adjustment member 302 from the elevation adjustment control 116 and the elevation adjuster 308 may result in angular vertical movement around or about the flexure axis 314, resulting in angular vertical adjustment of the optical path 130 and the holographic image provided to the rear window 110 in an operator's viewing area.

In another example, the windage adjustment control 118 may include a windage adjuster 310 which extends through the base 102 to engage the second surface 306 of the adjustment member 302. An operator may turn the windage adjustment control 118, which results in the windage adjuster 310 engaging with the second surface 306 of the adjustment member 302. As the operator turns the windage adjustment control 118, the windage adjuster 310 applies more or less force to the second surface 306 of the adjustment member 302, which moves the adjustment member a distance corresponding to the degree of rotation of the windage adjuster. The mounting portion 312 may include a mounting screw 316 or other fastener which extends through an aperture 606 in a planar surface of the mounting portion 312 along a vertical axis configured as a second sighting axis (i.e., a rotational axis 320). Thus, the adjustment assembly 300 may be configured to move the chassis 128 about a sighting axis relative to the housing 114, where the sighting axis when operating the windage adjustment control 118 may be a rotational axis. The mounting screw 316 may mechanically couple the optical component carrier 126 to the housing 114. A gasket 318 may be provided between the mounting screw 316 and the mounting portion 312. As the windage adjuster 310 applies more or less force to the second surface 306 of the adjustment member 302, the chassis 128 may rotate about the gasket 318 and the rotational axis 320, thus allowing the chassis 128 and the optical path 130 illuminating the holographic image formed through the plurality of optical components to move or be angularly displaced relative to the rotational axis 320. Thus, horizontal force applied to the second surface 306 of the adjustment member 302 from the windage adjustment control 118 and windage adjuster 310 may result in angular horizontal movement around or about the rotational axis 320, resulting in angular horizontal adjustment of the optical path 130 of the holographic image provided to the rear window 110 in an operator's viewing area.

In additional examples, it is conceivable that an adjustment assembly may be configured to move the chassis about a sighting axis relative to the housing, where the sighting axis when operating the windage adjustment control may be a flexure axis and/or where the sighting axis when operating the elevation adjustment control may be a rotational axis.

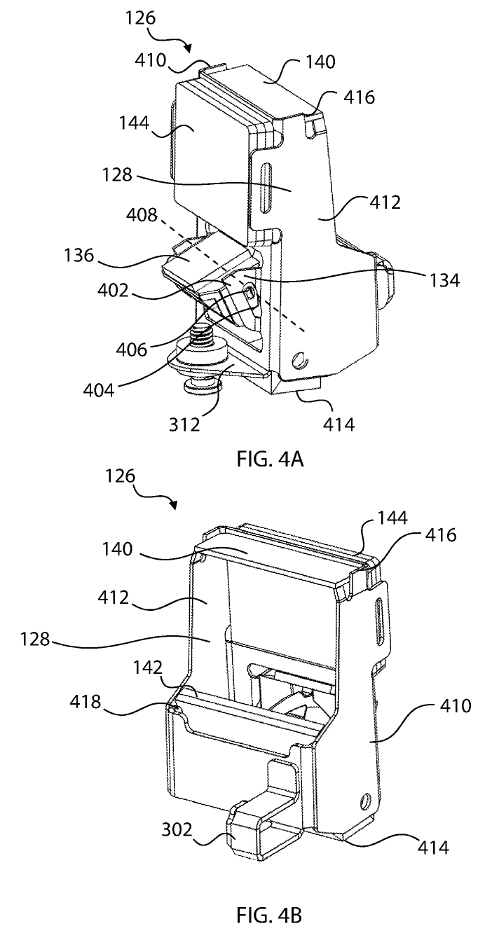

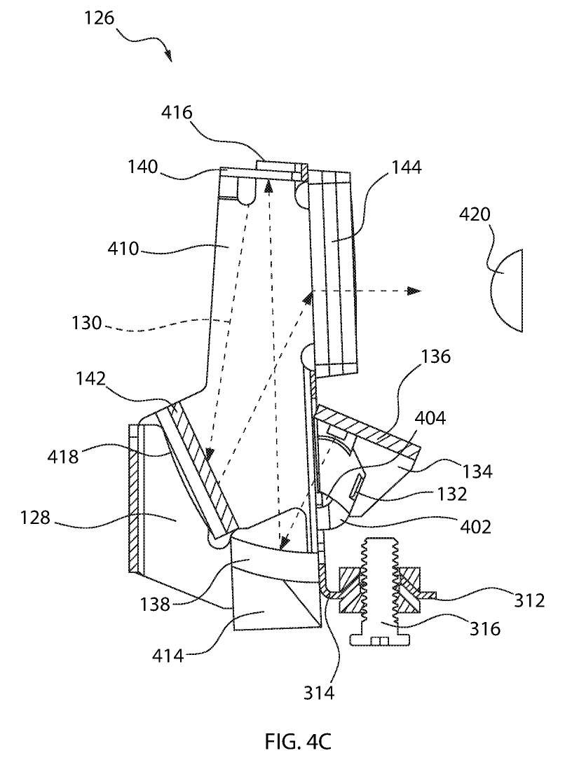

FIGS. 4A and 4B depict perspective views of the optical component carrier 126 with the plurality of optical components fixed to the chassis 128. FIG. 4C depicts a cross-sectional view of the chassis 128 illustrating the optical path 130 between the plurality of optical components. The chassis 128 may be comprised of a metal sheet formed to support the plurality of optical components.

The metal sheet of the chassis 128 may be formed to at least partially define an optical window that aligns with a viewing window of the housing 114 and a plurality of optical component receptacles for supporting the optical components. In some examples, the receptacles may be surfaces of the chassis 128 to which the optical components are adhered. The chassis 128 may include mating surfaces 500 and/or walls that align each of the optical components with their respective receptacle. For example, the chassis 128 may include a plurality of fixed optical component receptacles for adhering the collimating optic 138, the mirror 140, the diffraction grating 142, and the image hologram 144 to the chassis 128. Mating surfaces and/or walls may dictate where the optical components are placed in the fixed optical component receptacles such that alignment of the optical components is provided based on their fixed location.

In examples, the collimating optic 138 may have a depth that is generally equal to the depth of the chassis 128, such that the ends of the collimating optic 138 align with the vertical walls 410, 412 of the chassis 128. Moreover, the collimating optic 138 additionally includes a parabolic surface that aligns with a parabolic bottom surface 414 of the chassis 128 and a width generally equal to the width of the chassis 128. In this manner, the bottom surface 414 and the vertical walls 410, 412 of the chassis 128 assist with aligning the collimating optic 138 in the chassis 128 for proper alignment of the optical component. In another example, the mirror 140 similarly has a depth that is generally equal to the depth of the chassis 128, such that the ends of the mirror 140 align with the vertical walls 410, 412 of the chassis 128. Moreover, the chassis 128 includes an upper surface 416 upon which the planar surface of the mirror 140 aligns and has a width that is generally equal to the width of the mirror 140. Thus, the upper surface 416 and the vertical walls 410, 412 of the chassis 128 assist with aligning the mirror 140. The diffraction grating 142 has a width that is generally equal to the width of the chassis 128. The chassis 128 includes an angled surface 418 configured such that the diffraction grating 142 rests against the angled surface 418, such that the angled surface 418 assists with aligning the diffraction grating 142. The image hologram 144 includes a width that is generally equal to the width of the chassis 128. The upper surface of the image hologram 144 may be aligned with the upper surface 416 of the chassis 128 to assist with aligning the image hologram 144. In this manner, the surfaces of the chassis 128 assist with aligning the collimating optic 138, the mirror 140, the diffraction grating 142, and the image hologram 144 such that the optical elements are properly aligned to provide the correct optical path between each of the optical elements. Each of the optical elements may be secured and/or adhered to their respective fixed optical component receptacles.1

Once the fixed optical component receptacles are secured with their respective optical elements, the light source 132 may be aligned and attached to the chassis 128. The chassis 128 may include an adjustable optical component receptacle 402 for adhering the light source 132 to the chassis 128. In an example, the adjustable optical component receptacle 402 may include a first receptacle part (i.e., a carrier 134) and a second receptacle part (i.e., a control board 136). The carrier 134 may be configured to allow for adjustment of the light source in at least a first and second direction, and the control board 136 may be configured to allow for adjustment of the light source in at least a third direction. The carrier 134 for the light source 132 may be provided in the adjustable optical component receptacle 402, which allows for adjustment of the position of the carrier 134 prior to adhering and fixing the carrier 134 in place. As such, the carrier 134 may be adjusted to properly align the light source 132 with the other optical components, and in particular the collimating optic 138, prior to the carrier 134 being fixed in position relative to the chassis 128. The adjustable optical component receptacle 402 may include a receptacle aperture 404 for receiving a carrier fastener 406, which extends along a carrier axis 408. The receptacle aperture 404 may be configured to receive the carrier fastener 406 and allow adjustment of the position of the carrier 134 via the carrier fastener 406 in the receptacle aperture 404 in at least one of a linear direction in the receptacle aperture 404 and a pivotable direction about the carrier axis 408. The control board 136 for the light source 132 is a planar member that is positionable on a planar surface of the carrier 134, allowing planar movement of the light source 132 relative to the carrier 134. The carrier 134 may be adjusted in a first linear direction along the receptacle aperture 404 and in a second pivotable direction about the carrier axis 408 to properly align the light source 132 with the collimating optic 138. The control board 136 provides adjustment in a third direction via planar movement on the carrier surface, providing at least three degrees of freedom for light source alignment before the carrier 134 and control board 136 are fixed to the chassis 128. Thus, the light source 132 is provided with at least a first and second degree of movement via the carrier 134 and at least a third degree of movement via the control board 136. In this manner, the light source 132 may be properly aligned with the collimating optic 138 and the remaining optical components prior to fixing the location of the light source during manufacturing of the optical component carrier 126. Once aligned, the chassis 128 and the control board 136 may be adhered to a fixed position relative to the chassis 128 to remain aligned with the other optical components to maintain the optical path illuminating the holographic image.

Once all optical components (i.e., the light source 132, the collimating optic 138, the mirror 140, the diffraction grating 142, and the image hologram 144) are aligned, the optical path 130 travels from the light source 132, reflecting the beam off each optical component to the rear window to illuminate the holographic image in the viewing window defined by the chassis 128 and the housing 114 for the operator 420 to see through the rear window 110. With the optical components aligned and affixed to their respective receptacles, the relative positions between all optical components remain fixed. During elevation and windage adjustments via the adjustment assembly 300, the entire optical component carrier 126 moves as a unitary structure about the sighting axis, maintaining the fixed spatial relationships between the light source 132, collimating optic 138, mirror 140, diffraction grating 142, and image hologram 144.

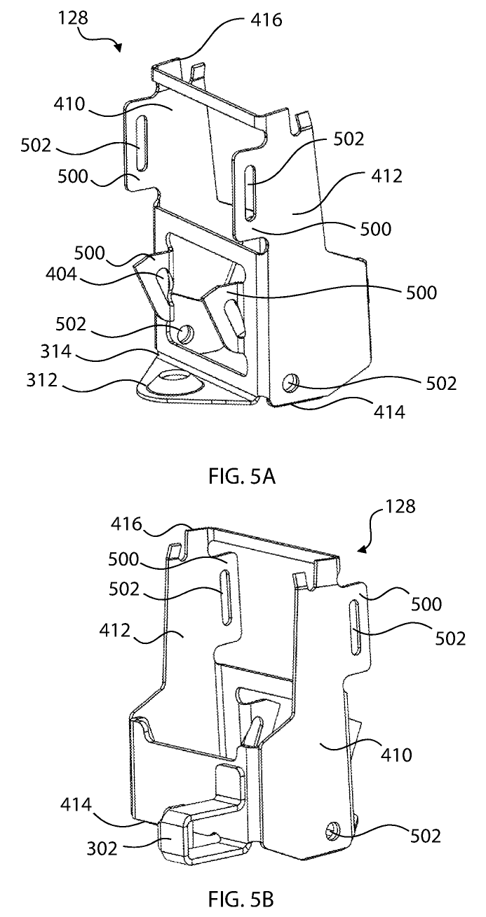

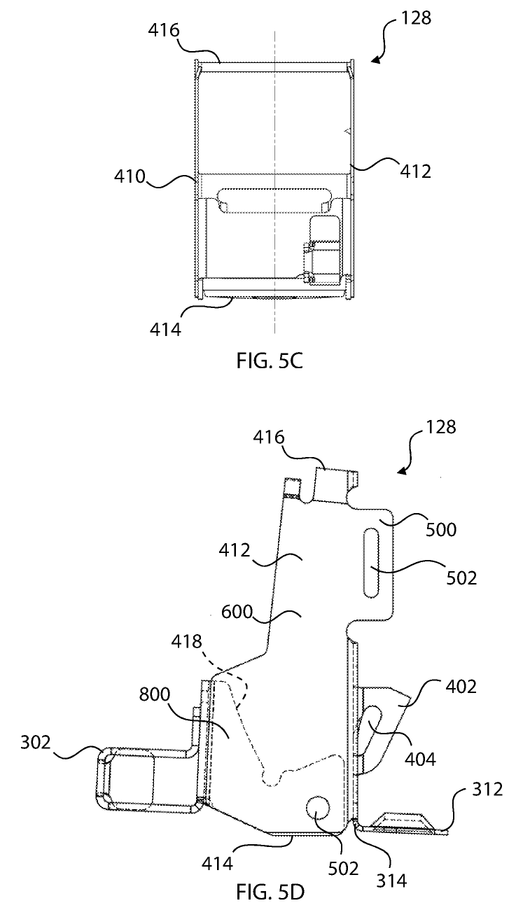

FIGS. 5A-5D depict the chassis 128 of the optical component carrier 126 without the plurality of optical components attached to the chassis 128. The chassis 128 may be comprised of metal sheet. For example, the metal sheet may be stamped to form the chassis 128. The metal sheet may include a plurality of mating surfaces 500 and/or define a plurality of attachment apertures 502. The attachment surfaces 500 and attachment apertures 502 are configured to align the optical components with the receptacles and to provide a larger surface area to adhere the plurality of optical components to the chassis 128.

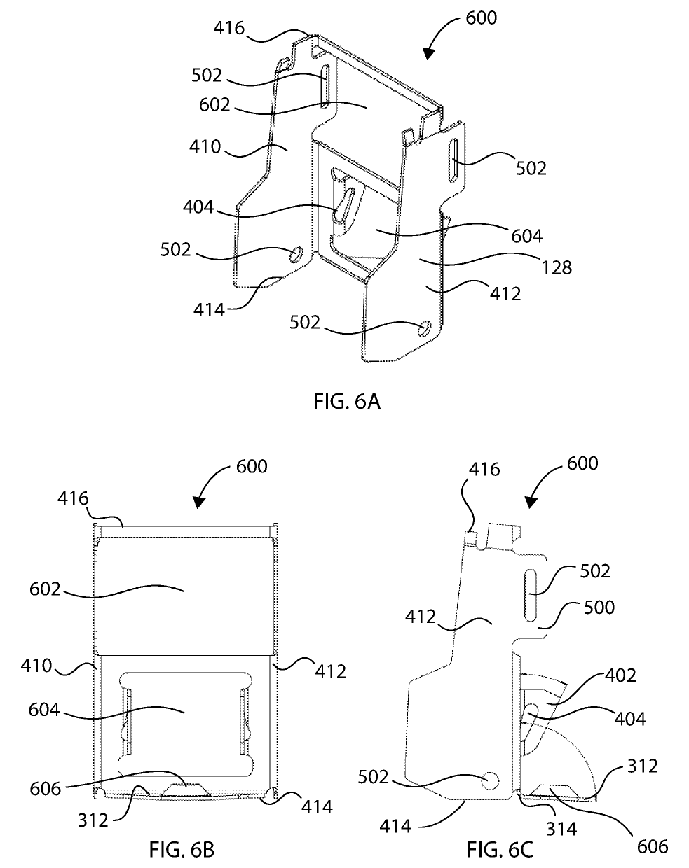

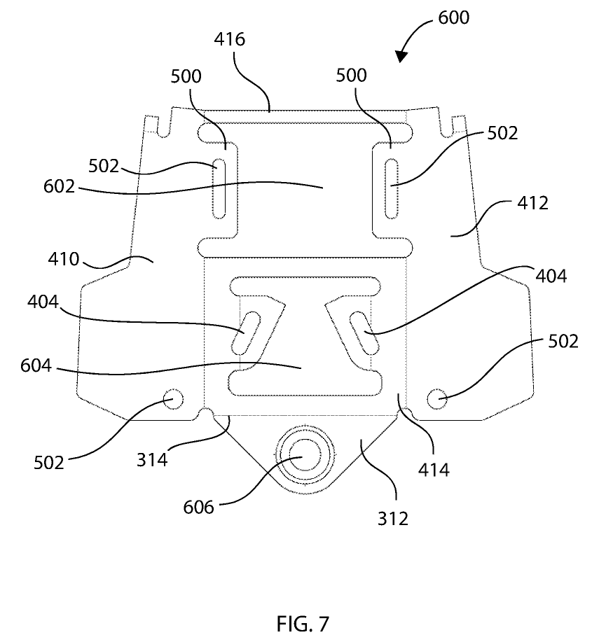

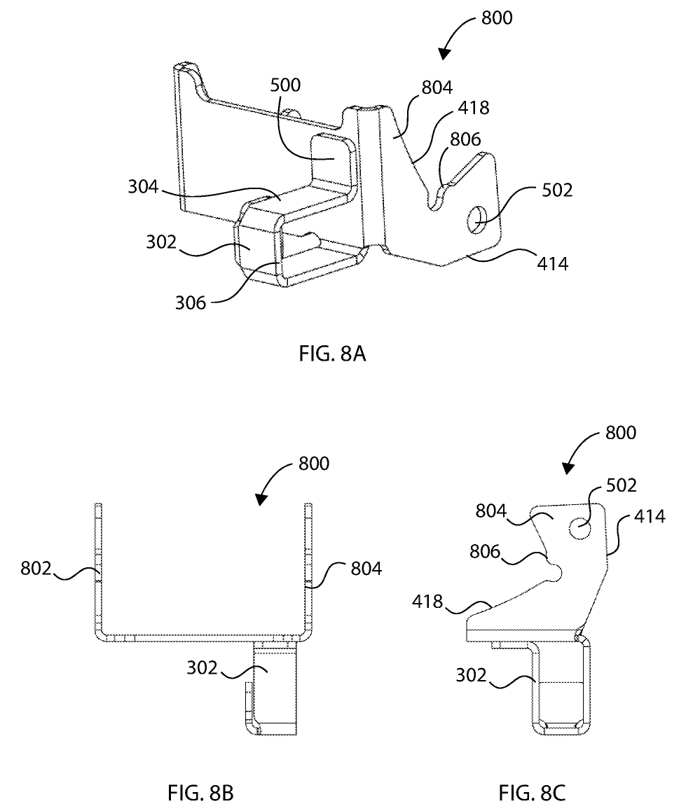

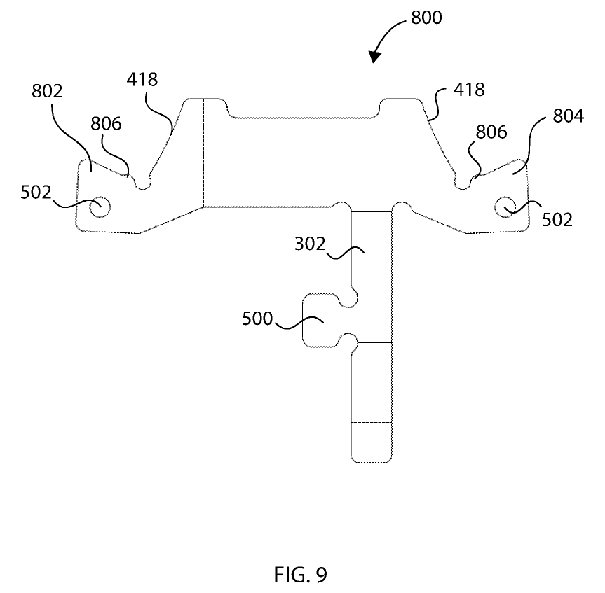

In some examples, the chassis may be comprised of a first carrier part comprised of a first metal sheet 600 and a second carrier part comprised of a second metal sheet 800. FIGS. 6A-6C illustrate the first metal sheet 600 after stamping. FIG. 7 illustrates the first metal sheet 600 prior to stamping. FIGS. 8A-8C illustrate the second metal sheet 800 after stamping. FIG. 9 illustrates the second metal sheet 800 prior to stamping. The first and second metal sheets 600, 800 may be stamped or otherwise bent into formation and welded or otherwise coupled to each other to define the chassis 128 and at least partially define the optical component receptacles prior to the plurality of optical components being loaded onto the chassis 128.

The first metal sheet 600 forms the first carrier part of the chassis 128, including the mounting portion 312 and the carrier portion having at least one of the receptacles for supporting the optical components, including the image hologram 144, the mirror 140, the light source 132, the carrier 134, and the collimating optic 138. The first sighting axis (i.e., the flexure axis 314) is defined by a bend in the first metal sheet 600 between the carrier portion of the chassis 128 and the mounting portion 312. The first metal sheet 600 may define the optical window (i.e., the image hologram aperture) 602 for aligning with the image hologram 144 and the rear window 110 of the housing 114. The first metal sheet 600 may also include a carrier aperture 604 for aligning with the carrier 134 of the light source 132. In this way, the optical path 130 may travel from the light source 132 to the collimating optic 138 through the carrier aperture 604 and from the diffraction grating 142 to the image hologram 144 through the optical window 602 without being interrupted by the first metal sheet 600. The first metal sheet 600 includes the mounting aperture 606 for receiving the mounting screw 316 in the planar surface of the mounting portion 312.

The second metal sheet 800 is formed to define the second carrier part of the chassis 128, including the adjustment member 302 and defining at least partially the receptacles for the diffraction grating 142. The adjustment member 302 may be an extension of the second metal sheet 800, which is bent to create the U-shaped arm. The adjustment member 302 may include an attachment surface 500 for welding the adjustment member 302 in place to remain fixed relative to the carrier portion of the chassis 128, such that forces applied to the first surface 304 and the second surface 306 of the adjustment member 302 are transferred to the carrier portion and direct movement of the chassis 128 about the sighting axis (i.e., the flexure axis 314 and/or the rotational axis 320). The second metal sheet 800 includes an angled surface 418 that at least partially defines the receptacle for the diffraction grating 142. The angled surface may include a first angled side wall 802 and a second angled side wall 804. The first and second angled side walls 802, 804 may be configured to be welded or otherwise affixed to the first and second vertical walls 410, 412 of the first carrier part of the chassis 128 defined by the first metal sheet 600. The first and second angled side walls 802, 804 may include a protrusion 806 or other surface that assists with aligning the diffraction grating 142 against the angled surface 418 of the first and second angled side walls 802, 804. The second metal sheet 800 may also include at least a portion of the bottom surface 414 for at least partially defining a portion of the receptacle for the collimating optic 138.

Thus, according to the disclosure, an optical component carrier for coupling with a housing of a holographic sight includes a chassis and an adjustment member. The chassis may be comprised of a metal sheet formed to at least partially define an optical window and a mating surface. The mating surface may be configured to support an optical component used for illuminating a holographic image in the optical window. The chassis may be configured to move about a sighting axis relative to the housing for positional adjustment of the optical window and the illuminated holographic image in a viewing window defined by the housing. The adjustment member may be fixed to the chassis and may include a first surface and a second surface orthogonal to the first surface. At least one of the first surface or the second surface may be configured to receive a force to drive movement of the chassis about the sighting axis.

Also according to the disclosure, a holographic weapon sight may include a housing and an optical component carrier for coupling with the housing. The optical component carrier may include a first carrier part, a second carrier part, and a plurality of optical components. The first carrier part may be comprised of a first metal sheet having at least a mounting portion and defining a first optical component receptacle. The second carrier part may be comprised of a second metal sheet having an adjustment member and defining a second optical component receptacle. The plurality of optical components may be fixedly attached to the first and second optical component receptacles. The adjustment member may be configured to move the optical component carrier relative to the housing about a sighting axis of the mounting portion.

Also according to the disclosure, an optical component carrier for coupling with a housing of a holographic sight may include a chassis comprising a metal sheet. The metal sheet may at least partially define a fixed optical component receptacle configured to support an optical component, and an adjustable optical component receptacle including a light source. The light source may be configured to emit a light path to the optical component. The adjustable optical component receptacle may include a first receptacle part and a second receptacle part. The first receptacle part may be configured for adjusting the light source in a first direction and a second direction. The second receptacle part may be configured for adjusting the light source in at least a third direction.

Also according to the disclosure, an optical component carrier for coupling with a housing of a holographic sight may include a chassis and a plurality of optical components. The chassis may be comprised of a metal sheet formed to at least partially define a plurality of optical component receptacles. The plurality of optical components includes at least a light source and an image hologram for illuminating a holographic image in an optical window. Each of the plurality of optical components is secured to a respective optical component receptacle and configured to move in unison with the optical component carrier relative to the housing for positional adjustment of the displayed holographic image.

Also according to the disclosure, a holographic weapon sight may include a housing and a pre-assembled unitary optical component carrier insertably attached to the housing. The pre-assembled unitary optical component carrier may include a chassis comprised of a metal sheet including a carrier portion and a mating portion and formed to at least partially define an optical window and a plurality of receptacles. The pre-assembled unitary optical component carrier may also include a plurality of optical components each attached to a respective receptacle and configured to illuminate a holographic image to the optical window. The optical components may be configured to move dependently on the chassis about a sighting axis of the mating portion relative to the housing for positional adjustment of the holographic image in the optical window. The pre-assembled unitary optical component carrier may be connected to the housing by a fastener of the mating portion.

Also according to the disclosure, a method of manufacturing a holographic sight may include assembling an optical component carrier, providing an optical housing, insertably attaching the optical component carrier into an opening of the optical housing, and securing the optical component carrier to the optical housing. Assembling the optical component carrier may further include bending a first metal sheet into a first carrier part, bending a second metal sheet into a second carrier part, welding the first carrier part and the second carrier part to form a chassis at least partially defining a plurality of receptacles, affixing a plurality of fixed optical components to each of the plurality of receptacles, aligning a light source with the fixed optical components, and affixing the light source in an aligned position to the fixed optical components.

A method of manufacturing the holographic sight 100 includes assembling the optical component carrier 126 as a complete sub-assembly before insertion into the housing 114. The first metal sheet 600 is stamped and bent into the first carrier part, and the second metal sheet 800 is stamped and bent into the second carrier part. The first and second carrier parts are welded together to form the chassis 128. The fixed optical components (mirror 140, collimating optic 138, diffraction grating 142, and image hologram 144) are affixed to their respective receptacles using the mating surfaces 500 for alignment. The light source 132 is then aligned with the fixed optical components by adjusting the carrier 134 and control board 136, and affixed in the aligned position. The pre-assembled optical component carrier 126 is then insertably attached into the opening of the housing 114 and secured via the mounting screw 316.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature; may be achieved with the two components (electrical or mechanical) and any additional intermediate members being integrally formed as a single unitary body with one another or with the two components; and may be permanent in nature or may be removable or releasable in nature, unless otherwise stated.

The articles “a,” “an,” and “the” are intended to mean that there are one or more of the elements in the preceding descriptions. The terms “comprising,” “including,” and “having” are intended to be inclusive and mean that there may be additional elements other than the listed elements.

Additionally, it should be understood that references to “one embodiment” or “an embodiment” of the present disclosure are not intended to be interpreted as excluding the existence of additional implementations that also incorporate the recited features. Furthermore, the terms “first,” “second,” and the like, as used herein do not denote any order, quantity, or importance, but rather are used to denote one element from another.

Numbers, percentages, ratios, or other values stated herein are intended to include that value, and also other values that are “about” or “approximately” the stated value, as would be appreciated by one of ordinary skill in the art encompassed by implementations of the present disclosure. A stated value should therefore be interpreted broadly enough to encompass values that are at least close enough to the stated value to perform a desired function or achieve a desired result. For example, the terms “approximately,” “about,” and “substantially” may refer to an amount that is within less than 5% of, within less than 1% of, within less than 0.1% of, and within less than 0.01% of a stated amount.

Further, it should be understood that any directions or reference frames in the preceding description are merely relative directions or movements. For example, the terms “upper,” “lower,” “right,” “left,” “rear,” “front,” “vertical,” “horizontal,” and derivatives thereof shall relate to the orientation shown in FIG. 1. However, it is to be understood that various alternative orientations may be provided, except where expressly specified to the contrary. It is also to be understood that the specific devices and processes illustrated in the attached drawings, and described in this specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Changes and modifications in the specifically described embodiments may be carried out without departing from the principles of the present invention, which is intended to be limited only by the scope of the appended claims as interpreted according to the principles of patent law. The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. An optical component carrier for a holographic weapon sight, the optical component carrier comprising:
a chassis comprising a metal sheet formed to at least partially define an optical window and a mating surface configured to support an optical component used for illuminating a holographic image in the optical window, the chassis configured to move about a sighting axis relative to a housing of the holographic weapon sight for positional adjustment of the optical window and the illuminated holographic image in a viewing window defined by the housing; and
an adjustment member fixed to the chassis and having a first surface and a second surface orthogonal to the first surface,
wherein at least one of the first surface or the second surface is configured to receive a force to drive movement of the chassis about the sighting axis.

2. The optical component carrier of claim 1, wherein the sighting axis includes a first axis and the first surface of the adjustment member is configured to receive force to drive movement of the chassis about the first axis.

3. The optical component carrier of claim 2, wherein the sighting axis includes a second axis and the second surface of the adjustment member is configured to receive force to drive movement of the chassis about the second axis.

4. The optical component carrier of claim 1, wherein the metal sheet of the chassis includes a bend defining a mounting flange, and wherein flexure of the mounting flange about the bend defines the sighting axis.

5. The optical component carrier of claim 1, wherein the chassis comprises a second metal sheet including the adjustment member.

6. The optical component carrier of claim 5, wherein the second metal sheet is formed to at least partially define a second mating surface configured to support a diffraction grating.

7. The optical component carrier of claim 1, wherein the metal sheet includes a carrier portion supporting the optical component and a mounting portion extending from the carrier portion, and wherein the sighting axis is configured as a flexure axis between the carrier portion and the mounting portion.

8. The optical component carrier of claim 7, wherein the sighting axis is configured as a rotational axis extending through an aperture in the mounting portion.

9. The optical component carrier of claim 1, wherein the metal sheet of the chassis defines a plurality of mating surfaces configured to support a plurality of optical components, including a light source, a mirror, and a collimating optic.

10. A holographic weapon sight, comprising:
a housing; and
an optical component carrier coupled with the housing and comprising:
a first carrier part comprising a first metal sheet having at least a mounting portion and a carrier portion defining a first optical component receptacle;
a second carrier part fixedly attached to the first carrier part, the second carrier part comprising a second metal sheet having an adjustment member and defining a second optical component receptacle; and
a plurality of optical components fixedly attached to the first and second optical component receptacles,
wherein the adjustment member is configured to move the optical component carrier relative to the housing about a sighting axis of the mounting portion.

11. The holographic weapon sight of claim 10, wherein the adjustment member includes a surface configured to receive a force to move the optical component carrier about the sighting axis.

12. The holographic weapon sight of claim 10, wherein the sighting axis is defined by a bend in the first carrier part, and the adjustment member is configured to move the optical component carrier relative to the housing about the sighting axis by flexure of the bend.

13. The holographic weapon sight of claim 10, wherein the sighting axis is defined by an aperture in a planar surface of the mounting portion, and wherein a mounting screw extends through the aperture, and the adjustment member is configured to rotate the optical component carrier relative to the housing about the mounting screw.

14. The holographic weapon sight of claim 10, wherein the first metal sheet of the first carrier part defines a plurality of optical component receptacles that support a light source, a mirror, an image hologram, and a collimating optic, and wherein the second optical component receptacle is configured to support a diffraction grating.

15. The holographic weapon sight of claim 10, wherein the plurality of optical components are configured to move in unison for positional adjustment of a displayed holographic image while maintaining fixed relative positions to each other.

16. A method of manufacturing a holographic weapon sight, comprising:
assembling an optical component carrier, including:
bending a first metal sheet into a first carrier part;
bending a second metal sheet into a second carrier part;
coupling the first carrier part and the second carrier part to form a chassis including a plurality of receptacles;
affixing a plurality of fixed optical components to each of the plurality of receptacles;
aligning a light source with the fixed optical components; and
affixing the light source in an aligned position to the fixed optical components;
providing an optical housing;
insertably attaching the optical component carrier into an opening of the optical housing; and
securing the optical component carrier to the optical housing.

17. The method of claim 16, wherein affixing the plurality of fixed optical components to each of the plurality of receptacles further includes:
affixing a mirror to a first receptacle;
affixing a collimating optic to a second receptacle;
affixing a diffraction grating to a third receptacle; and
affixing an image hologram to a fourth receptacle.

18. The method of claim 16, further comprising forming a sighting axis in the first metal sheet configured to flex the chassis about the sighting axis relative to the optical housing.

19. The method of claim 16, further comprising providing an adjustment assembly configured to move the chassis about a sighting axis relative to the optical housing, wherein the adjustment assembly includes an adjustment member having a first surface and a second surface orthogonal to the first surface.

20. The method of claim 16, wherein coupling the first carrier part and the second carrier part includes welding the first carrier part and the second carrier part together, and wherein the assembled optical component carrier is a pre-assembled unitary component insertably attached to the optical housing.
